(19) United States
(12) Patent Application Publication
(10) Pub. No.: US 2017/0341378 A1
(43) Pub. Date: Nov. 30, 2017

(54) LIQUID EJECTION HEAD SUBSTRATE, LIQUID EJECTION HEAD, AND LIQUID EJECTION APPARATUS

(71) Applicant: CANON KABUSHIKI KAISHA, Tokyo (JP)

(72) Inventors: Masataka Sakurai, Kawasaki-shi (JP); Ryo Kasai, Tokyo (JP); Kengo Umeda, Tokyo (JP); Hidenori Yamato, Tokyo (JP)

(21) Appl. No.: 15/602,525

(22) Filed: May 23, 2017

(30) Foreign Application Priority Data
May 30, 2016 (JP) 2016-107268
Apr. 24, 2017 (JP) 2017-085588

(51) Int. Cl. B41J 2/045; B41J 2/155

(52) U.S. Cl. CPC B41J 2/04541; B41J 2/155; B41J 2/04548; B41J 2202/21; B41J 2202/13

(57) ABSTRACT

A plurality of element arrays are formed between a first terminal array and a second terminal array by a plurality of elements. An element array positioned closer to the second terminal array than to the first terminal array is connected to the second terminal array. An element array positioned closer to the first terminal array than to the second terminal array is connected to the first terminal array.

### BACKGROUND OF THE INVENTION

### Field of the Invention

The present invention relates to a liquid ejection head substrate including a plurality of elements for generating ejection energy to eject liquid, a liquid ejection head using the liquid ejection head substrate, and a liquid ejection apparatus.

### Description of the Related Art

Japanese Patent Laid-Open No. 2013-49277 discloses, as an inkjet printing head substrate (liquid ejection head substrate), a substrate including a plurality of element arrays formed by a plurality of elements to generate ejection energy and one terminal array formed by a plurality of connection terminals. Elements in each element array are connected to connection terminals in one terminal array.

In the case of the substrate disclosed in Japanese Patent Laid-Open No. 2013-49277, only one terminal array is provided to a plurality of element arrays. Thus, a positional relation between the plurality of element arrays and the one terminal array may cause an increase difference in the distance between the respective element arrays and the terminal array. An increased number of element arrays in particular causes a remarkable difference in the interval between the element arrays and the terminal array. Such a difference may appear as a difference in the wiring resistance between the element arrays and the terminal array, which may cause a risk of a significant difference in the driving conditions of the elements in the respective element arrays.

### SUMMARY OF THE INVENTION

The present invention provides a liquid ejection head substrate, a liquid ejection head, and a liquid ejection apparatus by which a difference in the driving conditions of elements in the respective element arrays can be minimized even when the number of the element arrays is increased.

In the first aspect of the present invention, there is provided a liquid ejection head substrate, comprising:

a first terminal array in which a plurality of first terminals are arranged;

a second terminal array in which a plurality of second terminals are arranged along an arrangement direction of the first terminal array;

a first element array in which a plurality of first elements are arranged along the arrangement direction of the first terminal array, the first element array being provided between the first terminal array and the second terminal array and being adjacent to the first terminal array;

a second element array in which a plurality of second elements are arranged along the arrangement direction of the second terminal array, the second element array being provided between the first terminal array and the second terminal array and being adjacent to the second terminal array;

a third element array in which a plurality of third elements are arranged, the third element array being provided between the first element array and the second element array;

at least one of first wiring configured to connect the plurality of first terminals and the plurality of first elements;

at least one of second wiring configured to connect the plurality of second terminals and the plurality of second elements; and

at least one of third wiring configured to connect the plurality of third elements and at least one of the plurality of first terminals and the plurality of second terminals.

In the second aspect of the present invention, there is provided a liquid ejection head comprising a liquid ejection head substrate, wherein:

the liquid ejection head substrate includes:

a first terminal array in which a plurality of first terminals are arranged;

a second terminal array in which a plurality of second terminals are arranged along an arrangement direction of the first terminal array;

a first element array in which a plurality of first elements are arranged along the arrangement direction of the first terminal array, the first element array being provided between the first terminal array and the second terminal array and being adjacent to the first terminal array;

a second element array in which a plurality of second elements are arranged along the arrangement direction of the second terminal array, the second element array being provided between the first terminal array and the second terminal array and being adjacent to the second terminal array;

a third element array in which a plurality of third elements are arranged, the third element array being provided between the first element array and the second element array;

at least one of first wiring configured to connect the plurality of first terminals and the plurality of first elements;

at least one of second wiring configured to connect the plurality of second terminals and the plurality of second elements; and

at least one of third wiring configured to connect the plurality of third elements and at least one of the plurality of first terminals and the plurality of second terminals.

In the third aspect of the present invention, there is provided a liquid ejection apparatus, comprising:

a liquid ejection head including a liquid ejection head substrate; and

a supply unit for supplying liquid to the liquid ejection head,

wherein the liquid ejection head substrate includes:

a first terminal array in which a plurality of first terminals are arranged;

a second terminal array in which a plurality of second terminals are arranged along an arrangement direction of the first terminal array;

a first element array in which a plurality of first elements are arranged along the arrangement direction of the first terminal array, the first element array being provided between the first terminal array and the second terminal array and being adjacent to the first terminal array;

a second element array in which a plurality of second elements are arranged along the arrangement direction of the second terminal array, the second element array being provided between the first terminal array and the second terminal array and being adjacent to the second terminal array;

a third element array in which a plurality of third elements are arranged, the third element array being provided between the first element array and the second element array;

at least one of first wiring configured to connect the plurality of first terminals and the plurality of first elements;

at least one of second wiring configured to connect the plurality of second terminals and the plurality of second elements; and

at least one of third wiring configured to connect the plurality of third elements and at least one of the plurality of first terminals and the plurality of second terminals.

According to the present invention, a plurality of element arrays are connected to any of two terminal arrays or both of the two terminal arrays to reduce the difference in the wiring resistance between the element array and the terminal array(s) to thereby minimize the difference in the driving conditions of the elements in the respective element arrays.

Further features of the present invention will become apparent from the following description of exemplary embodiments with reference to the attached drawings.

### BRIEF DESCRIPTION OF THE DRAWINGS

FIG. 1A illustrates a configuration example of a liquid ejection apparatus in the first embodiment of the present invention, FIG. 1B is a perspective view illustrating a main part of the liquid ejection head in FIG. 1A;

FIG. 2A is a plan view illustrating a printing element substrate in FIG. 1B, FIG. 2B is an enlarged cross-sectional view taken along the line IIB-IIB of FIG. 2A;

FIG. 3 illustrates another configuration example of the printing element substrate;

FIG. 4A, FIG. 4B, and FIG. 4C illustrate still other configuration examples of the printing element substrate, respectively;

FIG. 5 illustrates a distribution method of image data;

FIG. 6A is a plan view illustrating the printing element substrate in the second embodiment of the present invention, FIG. 6B is a cross-sectional view taken along the line VIB-VIB of FIG. 6A;

FIG. 7 is a plan view illustrating the printing element substrate in the third embodiment of the present invention;

FIG. 8 is a plan view illustrating another example of the printing element substrate in the third embodiment of the present invention;

FIG. 9A is a plan view illustrating the printing element substrate in the fourth embodiment of the present invention, FIG. 9B is a cross-sectional view taken along the line IXB-IXB of FIG. 9A; and

FIG. 10 is a cross-sectional view of the printing element substrate in the fifth embodiment of the present invention.

### DESCRIPTION OF THE EMBODIMENTS

The following section will describe an embodiment of the present invention based on the drawings.

### First Embodiment

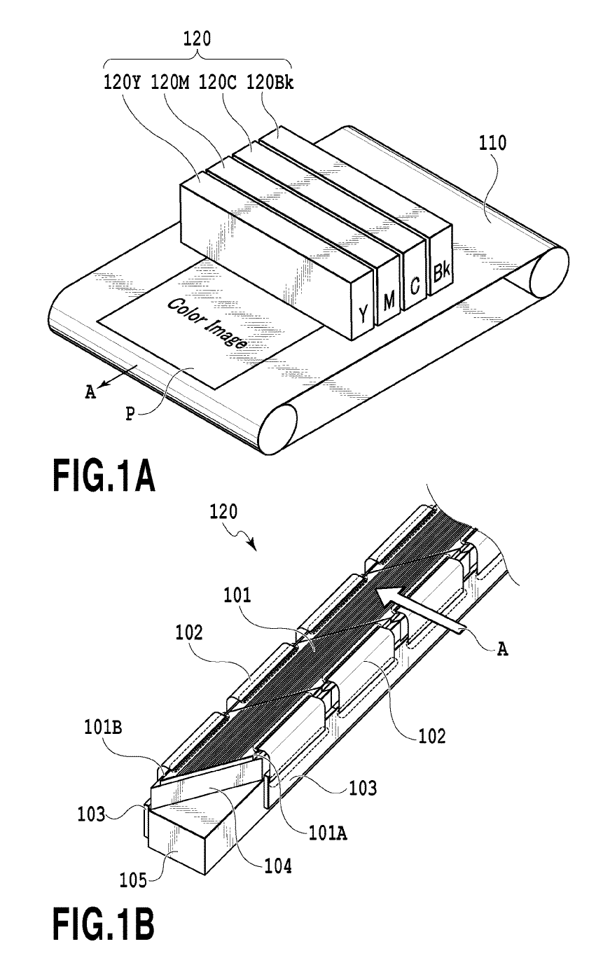

FIG. 1A is a schematic perspective view to explain a configuration example of inkjet printing apparatus (liquid ejection apparatus) using an inkjet printing head (liquid ejection head) of this embodiment. The printing apparatus of this example is a so-called full line-type one that uses a long printing head 120 extending over the entire range in the width direction of a printing medium P. The printing medium P is continuously conveyed in a direction shown by an arrow A by a conveying mechanism 110 using a conveying belt for example. An image is printed on the printing medium P by ejecting ink (liquid) through the printing head 120 while conveying the printing medium P in the direction shown by the arrow A. In the case of this example, the printing heads 120C, 120M, 120Y, and 120Bk for ejecting inks of cyan (C), magenta (M), yellow (Y), and black (K) can be used as the printing head 120 to thereby print a color image.

FIG. 1B is a perspective view illustrating the printing head 120. The printing head 120 of this example is a full multi head in which a plurality of printing element substrates (liquid ejection head substrates) 101 are provided in a serial manner in a direction crossing the conveying direction of the printing medium P (the direction shown by the arrow A) (a direction orthogonal thereto in the case of this example). As described later, the substrate 101 includes an electrothermal conversion element (heater) as an element to generate ejection energy to eject ink (ejection energy generation element). The ejection energy generation element also can be various elements such as a piezo element. A not-shown top plate includes an ejection opening corresponding to a heater (element). The top plate and the substrate 101 have therebetween a pressure chamber. A plurality of heaters are provided so as to form a plurality of heater arrays (element arrays). A plurality of ejection openings corresponding to these heaters similarly form a plurality of ejection opening arrays. The heater causes ink to foam by being energized via a pad (connection terminal) and a flexible substrate (which will be described later) to use the foaming energy to eject ink through a corresponding ejection opening. The substrate 101 also may be configured to include the top plate including the ejection openings.

The substrate 101 is configured so that two sides 101A and 101B substantially parallel to a heater array respectively have pad arrays (terminal arrays). These pad arrays are electrically connected to one end of the flexible substrate 102 having the same wiring pattern. The other end of the flexible substrate 102 is connected to a head substrate 103 having the same wiring pattern. The substrate 101 is provided on a flow path member 104 forming an ink flow path. In this example, one substrate 101 is adhered to one flow path member 104. A full multi head is configured by allowing a head base 105 to have thereon a plurality of configuration bodies obtained by integrating the flow path member 104 with the substrate 101. In the case of this example, these configuration bodies are adhered on the head base 105.

In this example, the pad of the substrate 101 is connected to the flexible substrate 102. However, the substrate 101 is not limitedly connected to the flexible substrate 102 and also may be connected to a rigid substrate such as the head substrate 103.

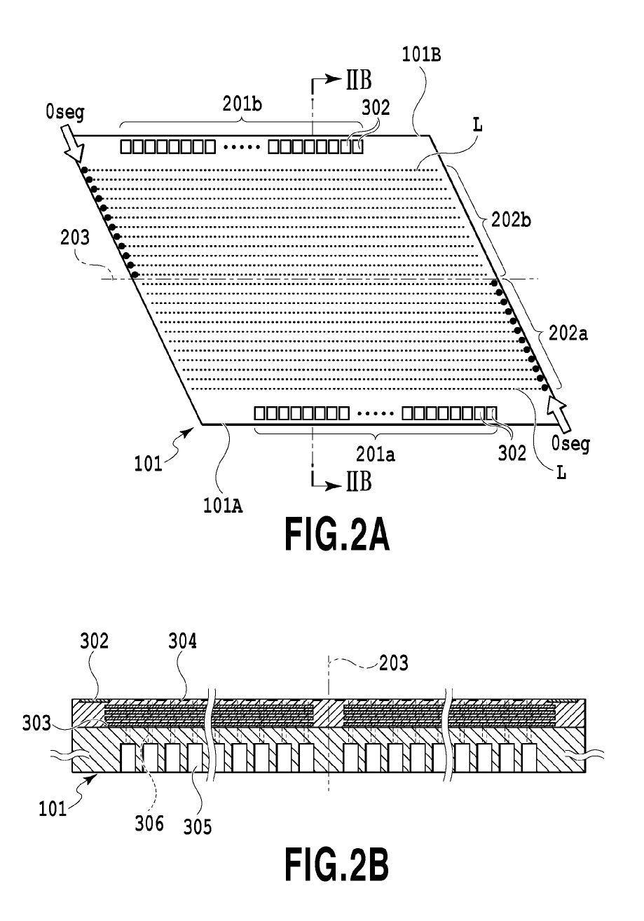

FIG. 2A is a schematic view to explain the configuration of a heater array and a pad array of the substrate 101. The substrate 101 has thereon a plurality of heater arrays (element arrays) L having thereon a plurality of heaters. A heater array group (a first element array group) 202a and a heater array group (the second element array group) 202b include a plurality of heater arrays L, respectively. In FIG. 2A, a heater positioned at the right end (segment “0”) in the heater array group 202a is represented by a large black circle. In FIG. 2A, a heater positioned at the left end (segment “0”) in the heater array group 202b is represented by a large black circle. The two sides 101A and 101B of the substrate 101 substantially parallel to these heater arrays L have a pad array (first terminal array) 201a and a pad array (second terminal array) 201b including a plurality of pads 302. A heater array L having a shorter interval to a pad array 201a than the other heater arrays (i.e., the heater array L in the vicinity of the pad array 201a) also may be called as a first element array. A heater array L having a shorter interval to a pad array 201b than the other heater arrays (i.e., a heater array in the vicinity of the pad array 201b) also may be called as the second element array. Heater arrays L other than the first and second element arrays may be also called as a third element array.

FIG. 2B is a cross-sectional view taken along the line IIB-IIB of FIG. 2A (a cross-sectional view in a direction orthogonal to the heater array L). In FIG. 2B, the upper face side of the substrate 101 has the pads 302, wirings 303, and heaters 304 forming the heater arrays L. In FIG. 2B, the lower side of the substrate 101 has a plurality of flow paths 305. The flow paths 305 are formed so as to correspond to the heater arrays L and distribute ink from the flow path member 104 (see FIG. 1B) to the respective heater arrays L. Supply openings 306 introduce the ink from the flow paths 305 to pressure chambers corresponding to the respective plurality of heaters 304. The supply opening 306 is formed so as not to interfere with the wiring 303. For simplifying the description, FIG. 2B does not show ejection openings opposed to the heaters 304 and flow paths configuration member (nozzle members) communicating with the ejection openings.

As shown in FIG. 2A, in this example, one ink color corresponds to 24 heater arrays L and thus 24 ejection opening arrays are formed so as to correspond to the 24 heater arrays L. An extremely high-speed printing operation is achieved by appropriately allocating printing data to these heater arrays L. When an ink ejection defect occurs in an ejection opening, ink can be ejected through other ejection opening arrays at a position corresponding to the ejection opening having the ejection defect in an interpolated manner in the conveying direction (the direction shown by the arrow A) of the printing medium P. This consequently improves the reliability of the printing operation, which is particularly preferred in a commercial printing field for example.

The substrate 101 in this example is configured so that the left and right parts in FIG. 2B having a center line 203 as a boundary are electrically separated. Specifically, the heater 304 forming the heater array L included in the heater array group 202a is connected to a data input terminal configured by the pad 302 included in the pad array 201a and is selectively driven depending on data inputted to the data input terminal. That is, depending on the data, the heater 304 as a driving target is selected from the heater array group 202a. The heater 304 forming the heater array L of the heater array group 202a is connected to a heater power source terminal configured by the pad 302 included in the pad array 201a. Driving current is supplied from the heater power source terminal. On the other hand, the heater 304 forming the heater array L included in the heater array group 202b is connected to a data input terminal configured by the pad 302 included in the pad array 201b and is selectively driven depending on data inputted to the data input terminal. Specifically, depending on the data, the heater 304 as a driving target is selected from the heater array group 202b. The heater 304 forming the heater array L of the heater array group 202b is connected to a heater power source terminal configured by the pad 302 included in the pad array 201b. Driving current is supplied from the heater power source terminal.

As described above, the pad array 201a provided on one side 101A of the substrate 101 is connected to the heater 304 in the heater array group 202a positioned in the vicinity thereof. On the other hand, the pad array 201b provided on the other side 101B of the substrate 101 is connected to the heater 304 in the heater array group 202b positioned in the vicinity thereof. As described above, the pad arrays 201a and 201b are associated with the heater array groups 202a and 202b.

The substrate 101 having the configuration as described above can reduce, when compared with a case where only one side of the substrate 101 has a pad array, difference of the voltage drop due to the wiring resistance between the pad array and the heater array. If only one side of the substrate 101 has a pad array, a small voltage drop is caused between the pad array and a heater array in the vicinity of the one side of the substrate 101. On the other hand, a large voltage drop is caused between the pad array and a heater array in the vicinity of the other side of the substrate 101. Therefore, an increased voltage drop difference therebetween is undesirably causes. The pad arrays 201a and 201b provided on the same substrate as in this embodiment can require, when compared with a case where the pad arrays 201a and 201b are provided on separate substrates, a reduced number of substrate(s), thus less requiring the positioning between substrates. Thus, according to this embodiment, the position accuracy between the heater arrays L can be easily secured in the heater array groups.

In this embodiment, the pad array 201a provided at one side 101A of the substrate 101 and the heater array L adjacent thereto (first element array) are connected via the wiring 303 (first wiring) provided closer to the side 101A than the center line 203. Similarly, the pad array 201b provided at the other side 101B of the substrate 101 and the heater array L adjacent thereto (second element array) are connected via the wiring 303 (second wiring) provided closer to the side 101B than the center line 203. In order to reduce the difference of the voltage drop caused by the wiring resistance between the pad array and the heater array, at least the configuration as described above may be used in which the pad array 201a and a first element array are connected and the pad array 201b and the second element array are connected.

The heater arrays (third element arrays) L except for the first element array and the second element array are connected to one of the pad array 201a and the pad array 201b via the wiring 303 (third wiring). The third wiring to connect the third element array included in the heater array group 202a to the pad array 201a is connected to the pad array 201a via the first wiring. The third wiring to connect the third element array provided in the heater array group 202b to the pad array 201b is connected to the pad array 201b via the second wiring. In order to reduce the wiring resistance between the pad arrays and the heater arrays, the heater array is preferably connected to the pad array closer thereto.

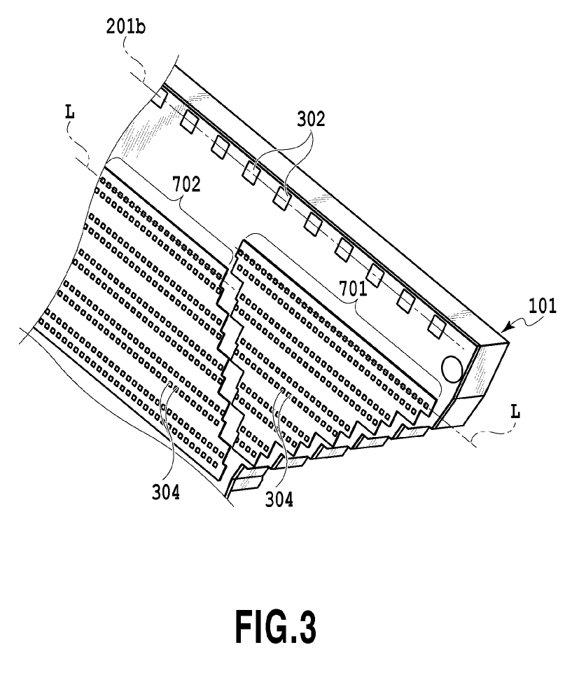

The heater array L is not limited to the embodiment as shown in FIG. 1B in which the heaters 304 are arranged to form a straight line. A part of the heater array L also may be displaced within the substrate 101. FIG. 3 is an enlarged view of the neighborhood of the pad array 201b to explain an example in which a part of the heater array L is displaced within the substrate 101. In the example of FIG. 3, the heater array L is displaced between the arrangement regions of the heater 304 (heater arrangement regions) 701 and 702. As in the configuration of FIG. 2A, in the heater arrangement regions 701 and 702 in such an example, the heater array L (first element array) positioned in the vicinity of the pad array 201a is connected to the pad array 201a. The heater array L (second element array) positioned in the vicinity of the pad array 201b is connected to the pad array 201b.

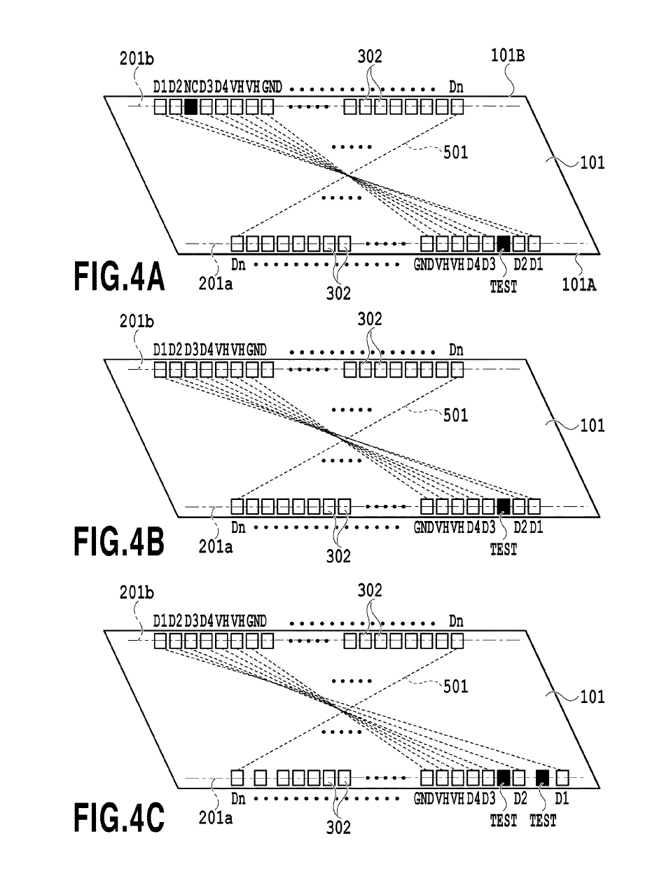

FIG. 4A, FIG. 4B, and FIG. 4C illustrate specific arrangement examples of the pads 302, respectively. In FIG. 4A, the pads 302 added with additional characters D1 to Dn represent data input terminals to input data signal to selectively drive the heaters 304, respectively. The reference numerals VH and GND represent a power source pad and a ground pad of the heaters 304 to configure heater power source terminals. The reference numeral NC represents a not-connected pad and the reference numeral TEST represents a test terminal used for the electric test of the substrate 101.

As shown in FIG. 4A, in the pad arrays 201a and 201b provided at the sides 101A and 101B of the substrate 101, the data input terminals (D1 to Dn) and the heater power source terminals (VH and GND) are generally provided in a rotationally-symmetric manner around the center of the substrate 101 as a reference. In the pad array 201a and the pad array 201b, the data input terminals (D1 to Dn) and the heater power source terminals (VH and GND) are arranged in reversed order in a direction along which the pad arrays extend.

When the pads 302 in the pad arrays 201a and 201b having similar functions are connected by broken lines 501, these broken lines 501 cross each other generally at the center of the printing substrate 101. The configuration as described above can provide the commonalization of the flexible substrate 102 connected to the substrate 101 of FIG. 1B and the flexible substrate 102 connected to the substrate 101 of FIG. 4A. Specifically, a case is assumed where the same data is inputted to the data input terminals (D1 to Dn) of the pad arrays 201a and 201b. In this case, the position of the heater 304 as a driving target in the heater array group 202a and the position of the heater 304 as a driving target in the heater array group 202b are rotationally-symmetric around the position between the heater array groups 202a and 202b as a center. The rotationally-symmetric center also functions generally as a center of the printing element substrate 101. As described above, the data input terminals (D1 to Dn) are arranged in the respective pad arrays 201a and 201b. The arrangement as described above allows, as will be described later, non-inverted image data to be distributed to one of the heater array groups 202a and 202b and inverted image data to be distributed to the other of the heater array groups 202a and 202b. Thereby, an image on the same raster can be separately printed by the plurality of heater arrays L.

Connection conditions to electrically connect the substrate to the flexible substrate by a wire bonding for example also can be communalized. The test terminal and the not-connected terminal (TEST, NC) not having an influence on the selective driving of the heaters 304 are not particularly required to be symmetrically arranged.

FIG. 4B illustrates another arrangement example of the pad 302s. In the arrangement example of FIG. 4B, the symmetric arrangement relation of the pads 302 in FIG. 4A is slightly displaced. In the case of this example, only the pad array 201a positioned at the side 101A of the substrate 101 has the test terminal (TEST) provided between the data input terminal D2 and the data input terminal D3. In the configuration as described above, when the pads 302 having similar functions in the pad arrays 201a and 201b are connected by the broken lines 501, the intersection points thereof is not one. This configuration similarly provides, as in the case of FIG. 4A, the commonalization of flexible substrates connected to the substrate. The reason is that maintaining the order of the data input terminals (D1 to Dn) and the heater power source terminals (VH, GND) allows the wire bonding wires to be connected to the same flexible substrate in an inclined manner.

FIG. 4C illustrates a still another arrangement example of the pads 302. In the case of this example, the pad array 201a at the side 101A of the substrate 101 has the total of two test terminals (TEST) provided between the data input terminal D1 and the data input terminal D2 and between the data input terminal D2 and the data input terminal D3, respectively. The data input terminal D1, test terminal (TEST), and the data input terminal D2 adjacent to one another are arranged to have a pitch thereamong that is different from a pitch among other pads 302. Even in such a configuration, maintaining the order of the arrangement of the heater power source terminals (VH, GND) allows the wire bonding wires to be connected to the same flexible substrate in an inclined manner

Electric circuits connected to the heater array groups 202a and 202b in the substrate 101 respectively also can be arranged to have a rotationally-symmetric relation to the substantial center of the substrate 101. Such an arrangement of a rotationally-symmetric relation of the electric circuits can reduce the burden on a circuit design.

Furthermore, the printing speed can be improved by allocating image data corresponding to ink of the same color to the plurality of heater arrays L in the substrate 101 so that the ink of the same color can be ejected through heater arrays L. In this case, in the plurality of the substrates 101 arranged in the length direction of the printing head 120, the heater arrays L in the substrates 101 adjacent to each other are arranged so as to be mutually overlapped in the conveying direction of the printing medium P corresponding to raster direction (the direction shown by the arrow A). This allows an image on the same raster to be printed using the plurality of the heaters 304 of the overlapped heater arrays L in the substrates 101 adjacent to each other. Specifically, the image on the same raster is printed by the ink ejected through the plurality of ejection openings corresponding to the plurality of the mutually-overlapped heaters 304.

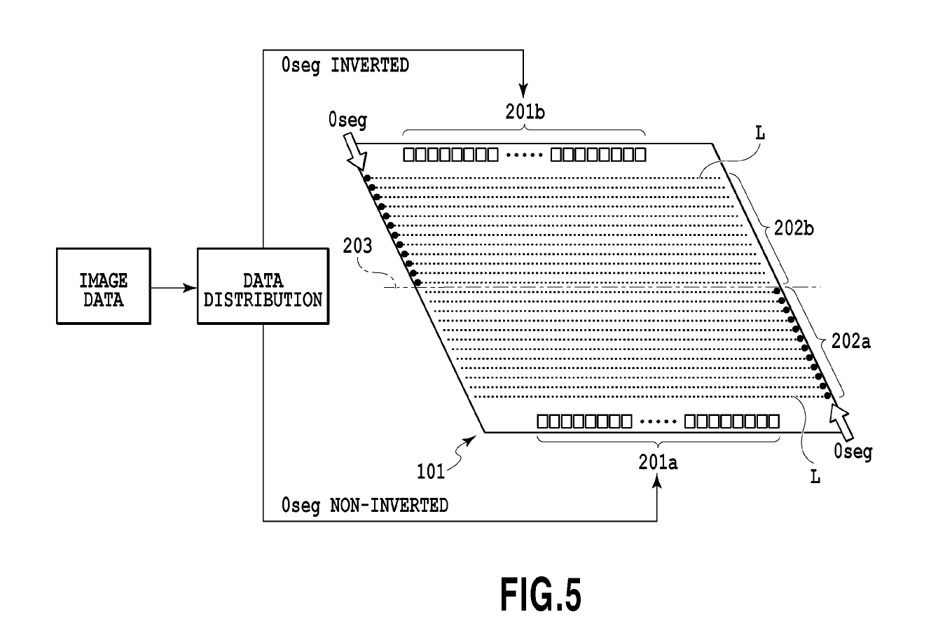

FIG. 5 is a conceptual diagram of a printing operation by the distribution of image data as described above. The image data is divided so as to correspond to the plurality of heater arrays L. For example, in the case where the pad arrays 201a and 201b are arranged in the rotationally-symmetric manner as described above, when image data inputted to the pad array 201a is normal image data (non-inverted image data), image date distributed to the pad array 201b is inverted image data corresponding to the segment layout of the heater array groups 202b. As a result, the image data is distributed to the plurality of heater arrays L in one substrate 101 so that the image on the same raster is printed by these heater arrays L.

### Second Embodiment

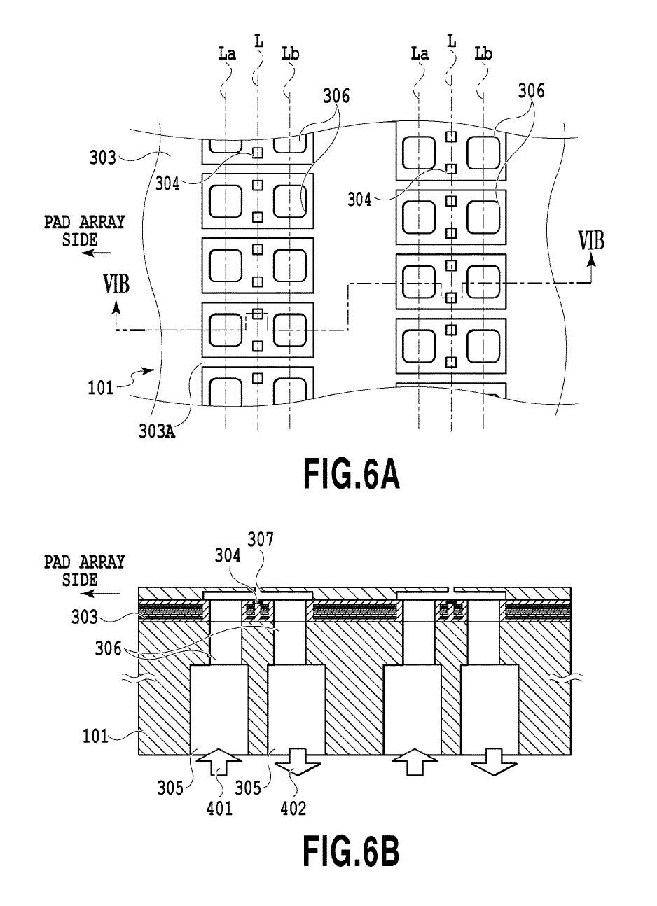

FIG. 6A is an enlarged plan view illustrating the heater array L of the printing element substrate 101 in the second embodiment of the present invention. FIG. 6B is a cross-sectional view taken along the line VIB-VIB of FIG. 6A. The same components as those of those in the above-described first embodiment are denoted with the same reference numerals and will not be described further.

In the substrate 101 of this embodiment, an arbitrary heater array L is positioned between two supply opening arrays La and Lb including the supply openings 306 of ink. Specifically, one heater array L is provided to two supply opening arrays La and Lb. A pressure chamber provided between the ejection opening 307 formed in the top plate and the corresponding heater 304 can receive ink circulated from one of the supply opening arrays La and Lb to the other. Specifically, the ink in the pressure chamber is circulated to the exterior. In this example, as shown by the arrow 401, the ink is introduced into the pressure chamber through the flow path 305 at the supply opening array La and the supply opening 306. As shown by the arrow 402, the ink in the pressure chamber is led out through the supply opening 306 (discharge opening) and the flow path 305 at the supply opening array Lb. The ink circulation as described above can suppress ink in the vicinity of the ejection opening 307 from having an increased viscosity and can suppress ink having an increased viscosity from being attached to the ejection opening 307 in a fixed manner. The ink circulation also can remove foreign matters such as dusts in the ejection opening 307 and the pressure chamber to thereby suppress an ink ejection defect caused by foreign matters from occurring.

The wiring 303 is provided only in a region except for the supply opening 306. Thus, the wiring 303 is provided in a small region between the supply openings 306, causing a narrow portion 303A of the wiring 303 as shown in FIG. 6A. For example, when the pad arrays positioned at the left side of FIG. 6A and FIG. 6B are connected to the heater arrays L in FIG. 6A and FIG. 6B by the wiring 303, an increase of the number of the heater arrays L connected to the pad arrays causes an increase of the narrow portions 303A existing between these pad arrays and the heater arrays. Specifically, an increase of the heater arrays L requires an increase of the total length of the narrow portions 303A between these heater arrays and the pad arrays connected thereto, consequently causing an increase of the wiring resistance therebetween. In this embodiment, as in the above-described embodiment, the heater array L positioned in the vicinity of the pad array 201a is connected to the pad array 201a and the heater array L positioned in the vicinity of the pad array 201b is connected to the pad array 201b. This consequently suppresses, when the ink circulation configuration is used as in this embodiment, an increase of the wiring resistance caused by the narrow portion 303A.

### Third Embodiment

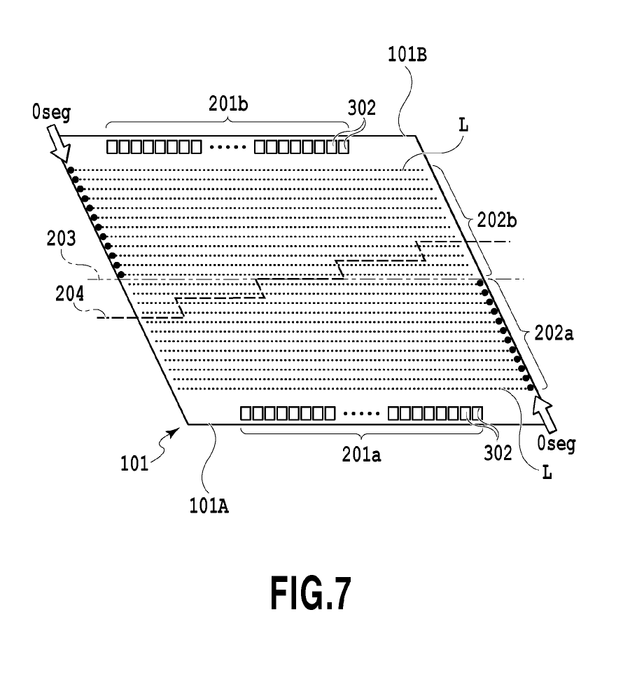

FIG. 7 is a schematic view to explain the configuration of heater arrays and pad arrays of the printing element substrate 101 in the third embodiment of the present invention. The same components as those of those in the above-described embodiment are denoted with the same reference numerals and will not be described further.

In the first embodiment, a wiring to selectively drive the heater 304 and a power source wiring to supply power source current to the heater 304 are both electrically separated at the center line 203 as a boundary. In the third embodiment, the wiring to selectively drive the heater is electrically separated at the center line 203 as a boundary as in the first embodiment. However, the power source wiring to supply power source current to the heater 304 is separated to the pad array 201a-side one and the pad array 201b-side one at another boundary line 204 as a boundary.

In the pad arrays 201a and 201b, when heater power source terminals (VH, GND) are provided in the vicinity of the center of the sides 101A and 101B of the substrate 101, then a difference in the wiring distance is caused depending on the heater 304 in the heater array L in the vicinity of the center line 203. Specifically, since the substrate 101 has a parallelogram plane, the heater array L in the vicinity of the center line 203 is configured so that a distance between the heater 304 at the segment “0” and the pad 302 is shorter than a distance between the heater 304 at the opposite segment and the pad 302. Therefore, the wiring resistance tends to be lower in the heater 304 at the segment “0” than in the heater 304 at the opposite segment. Thus, in this embodiment, the power source wiring is different from the wiring to selectively drive the heater so that the power source wiring is divided to the pad array 201a-side one and the pad array 201b-side one at a boundary line 204 partially exceeding the center line 203 as a boundary. The boundary line 204 in this example is formed in a step-wise manner. The reason is that the plurality of heaters 304 are separated to groups and the resultant groups of the heaters 304 are time-division driven by setting boundaries among the groups.

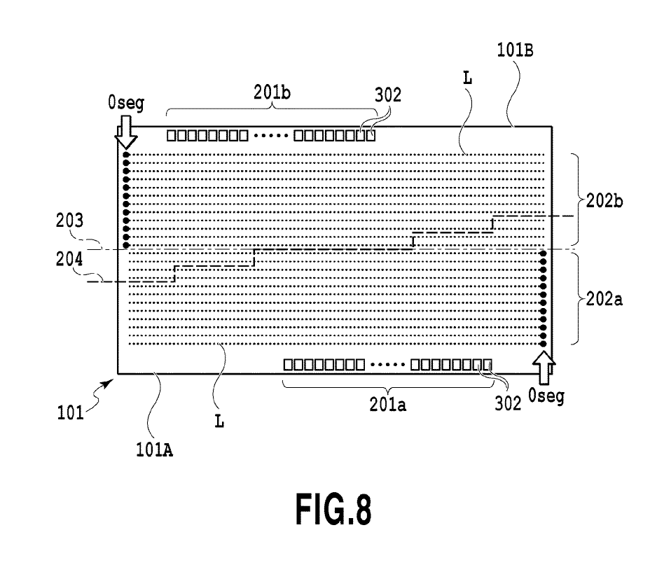

In this example, the substrate 101 has a parallelogram plane having an internal angle that is not a right angle. However, the substrate 101 is not limited to any shape. For example, even when the substrate 101 has a rectangular plane as shown in FIG. 8 and the heater power source terminals (VH, GND) are positioned at eccentric positions in the pad arrays 201a and 201b, the power source wiring can be separated at the boundary line 204 different from the center line 203 as a boundary.

### Fourth Embodiment

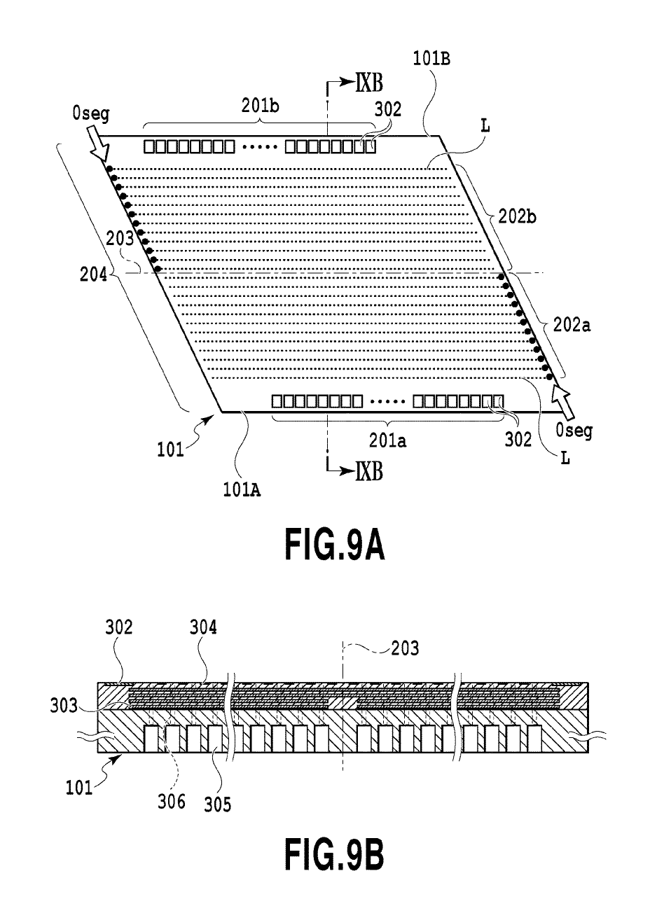

FIG. 9A is a schematic view to explain the configuration of the heater arrays and the pad arrays of the substrate 101 in the fourth embodiment of the present invention. In this embodiment, the wiring to selectively drive the heater is separated at the center line 203 as a boundary and the power source wiring of the heater 304 is electrically common.

FIG. 9B is a cross-sectional view taken along the line IX-IX of FIG. 9A (a cross-sectional view in a direction orthogonal to the heater arrays L). The wirings 303 are layered so as to form four wiring layers. Among the four layers, the two layer closer to the top face side of the substrate 101 (the upper face side of FIG. 9B) include the power source wiring to allow power source current to flow into the heater. In the case of this example, the power source wiring is formed so as to bridge over the center line 203. Thus, in the substrate 101, the pad arrays 201a and 201b are connected by the power source wiring, and the power source current flowing in the heater are allowed to flow in the power source terminals (VH, GND) in the respective pad arrays 201a and 201b. This can provide, when compared with a case where the power source wiring is separated, a smaller wiring resistance, thus suppressing the voltage drop due to the wiring resistance.

### Fifth Embodiment

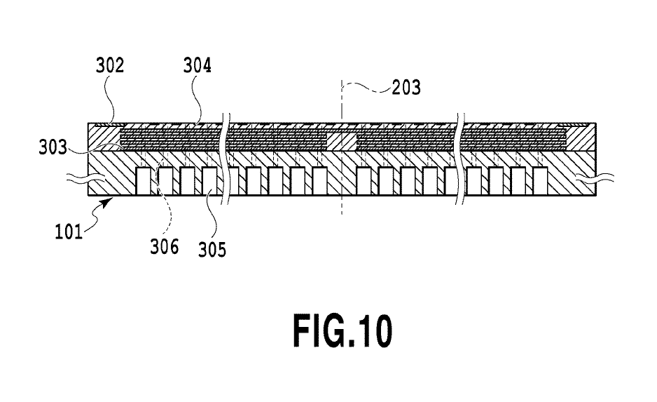

FIG. 10 is a cross-sectional view of the substrate 101 in the fifth embodiment of the present invention (a cross-sectional view in a direction orthogonal to the heater array L). The wirings 303 are layered so as to form four wiring layer. Among the four layers, the two layer closer to the top face side of the substrate 101 (the upper face side of FIG. 10) include the power source wiring to allow power source current to flow into the heater. Among these two layers, the power source wiring of one layer is formed so as to bridge over the center line 203. The power source wiring of the other layer is separated at the center line 203 as a boundary. The former power source wiring formed so as to bridge over the center line 203 is a ground wiring connected to the ground terminal GND. The latter power source wiring separated at the center line 203 as a boundary is a power source supply wiring connected to the power source terminal VH.

The ground wiring in this example is a reference potential of a not-shown driver transistor. When the current flowing in the wiring parasitic resistance causes a significant change in the reference potential of the driver transistor, a risk is caused in which a change of the transistor characteristic may prevent the heater from being driven stably. To prevent this, according to this example, the ground terminals GND of the pad arrays 201a and 201b are connected in the substrate 101 to thereby reduce the ground wiring resistance, suppressing the fluctuation of the reference potential of the driver transistor.

By the way, when the power source wirings of the pad arrays 201a and 201b are connected in the substrate 101, then current is allowed to flow in the pad arrays 201a and 202b in a distributed manner. The heater 304 as a printing element receives the electric power supplied from the body of the printing apparatus via another flexible substrate and a rigid substrate for example. When the wiring resistance other than the heater 304 is relatively high, the energization time of the heater 304 may be adjusted in order to compensate the voltage drop of the wiring other than the heater 304. However, when the power source wiring is communalized in the printing element substrate 101, it is difficult to know current flowing in the wirings of a flexible substrate and a rigid substrate separately connected to the pad arrays 201a and 201b. This consequently causes a risk of a lower accuracy of the adjustment of the energization time of the heater 304.

From the viewpoint as described above, in this example, the ground wiring has a reduced resistance and the power source supply wiring is separated in the substrate 101 at the center line 203 as a boundary as described above, thereby providing an improved accuracy of the adjustment of the energization time of the heater 304. Another configuration also may be used in which the ground wiring is separated in the substrate 101 and the power source supply wiring is communalized without being separated in the substrate 101 so that the power source supply wiring is used as a reference potential of the driver transistor. Another configuration also may be used in which, without depending on the reference potential of the driver transistor, one of the ground wiring and the power source supply wiring as the power source wiring is communalized and the other is separated, thereby providing a certain effect.

### Other Embodiments

The present invention is not limited to the full line-type printing apparatus and also may be applied to various types of printing apparatuses such as the so-called serial scan type one.

The present invention can be widely applied to a liquid ejection head substrate, a liquid ejection head, and a liquid ejection apparatus by which various liquids can be ejected. The present invention also can be applied to a liquid ejection apparatus in which a liquid ejection head through which liquid can be ejected is used to subject various media (including a sheet) to various processings (printing, machining, coating, illumination, reading, inspection). The media (including a printing medium) may include various media to which liquid including ink is applied such as paper, plastic, film, fabric, metal, or a flexible substrate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2016-107268 filed May 30, 2016, and No. 2017-085588 filed Apr. 24, 2017, which are hereby incorporated by reference wherein in their entirety.

What is claimed is:

1. A liquid ejection head substrate, comprising:
a first terminal array in which a plurality of first terminals are arranged;
a second terminal array in which a plurality of second terminals are arranged along an arrangement direction of the first terminal array;
a first element array in which a plurality of first elements are arranged along the arrangement direction of the first terminal array, the first element array being provided between the first terminal array and the second terminal array and being adjacent to the first terminal array;
a second element array in which a plurality of second elements are arranged along the arrangement direction of the second terminal array, the second element array being provided between the first terminal array and the second terminal array and being adjacent to the second terminal array;
a third element array in which a plurality of third elements are arranged, the third element array being provided between the first element array and the second element array;
at least one of first wiring configured to connect the plurality of first terminals and the plurality of first elements;
at least one of second wiring configured to connect the plurality of second terminals and the plurality of second elements; and
at least one of third wiring configured to connect the plurality of third elements and at least one of the plurality of first terminals and the plurality of second terminals.

2. The liquid ejection head substrate according to claim 1, wherein:
the third wiring is connected to at least one of the plurality of first terminals and the plurality of second terminals via at least one of the first wiring and the second wiring.

3. The liquid ejection head substrate according to claim 2, wherein:
the third wiring is connected to one of the plurality of first terminals and the plurality of second terminals via at least one of the first wiring and the second wiring.

4. The liquid ejection head substrate according to claim 2, wherein:
the third wiring connects the first wiring and the second wiring.

5. The liquid ejection head substrate according to claim 1, wherein:
an interval between the third element array and the first terminal array is different from an interval between the third element array and the second terminal array; and
the third wiring connects the third element array to one of the first terminal array and the second terminal array that is closer to the third element array.

6. The liquid ejection head substrate according to claim 1, wherein:
the third element array includes (i) an element array that is positioned closer to the first element array than to the second element array and that forms a first element array group together with the first element array and (ii) an element array that is positioned closer to the second element array than to the first element array and that forms a second element array group together with the second element array, and
the third wiring includes (iii) a wiring for connecting the first element array group and the first terminal array and (iv) a wiring for connecting the second element array group and the second terminal array.

7. The liquid ejection head substrate according to claim 1, wherein:
the third element array includes a plurality of third elements connected only to the plurality of first terminals and a plurality of third elements connected only to the plurality of second terminals.

8. The liquid ejection head substrate according to claim 6, wherein:
the first terminal array includes a plurality of first input terminals for inputting data to select a first element to be driven from the first element array group and a first power source terminal; and
the second terminal array includes a plurality of second input terminals for inputting data to select a second element to be driven from the second element array group and a second power source terminal.

9. The liquid ejection head substrate according to claim 8, wherein:
an arrangement order of the first input terminal and the first power source terminal in the first terminal array and an arrangement order of the second input terminal and the second power source terminal in the second terminal array are opposite orders.

10. The liquid ejection head substrate according to claim 8, wherein:
the plurality of first input terminals and the plurality of the second input terminals are arranged so that, when the same data is inputted to the plurality of first input terminals and the plurality of the second input terminal, the position of the first element to be driven in the first element array group and the position of the second element to be driven in the second element array group are rotationally-symmetric around a position between the first element array and the second element array as a center.

11. The liquid ejection head substrate according to claim 1, wherein:
the third wiring includes at least one of a power source supply wiring and a ground wiring.

12. The liquid ejection head substrate according to claim 1, wherein:
the plurality of first elements, the plurality of second elements, and the plurality of third elements are electrothermal conversion elements.

13. A liquid ejection head comprising a liquid ejection head substrate, wherein:
the liquid ejection head substrate includes:
a first terminal array in which a plurality of first terminals are arranged;
a second terminal array in which a plurality of second terminals are arranged along an arrangement direction of the first terminal array;
a first element array in which a plurality of first elements are arranged along the arrangement direction of the first terminal array, the first element array being provided between the first terminal array and the second terminal array and being adjacent to the first terminal array;
a second element array in which a plurality of second elements are arranged along the arrangement direction of the second terminal array, the second element array being provided between the first terminal array and the second terminal array and being adjacent to the second terminal array;
a third element array in which a plurality of third elements are arranged, the third element array being provided between the first element array and the second element array;
at least one of first wiring configured to connect the plurality of first terminals and the plurality of first elements;
at least one of second wiring configured to connect the plurality of second terminals and the plurality of second elements; and
at least one of third wiring configured to connect the plurality of third elements and at least one of the plurality of first terminals and the plurality of second terminals.

14. The liquid ejection head according to claim 13, wherein:
the liquid ejection head substrate includes a pressure chamber including therein any of the first, second, and third elements; and
liquid in the pressure chamber is circulated to the exterior of the pressure chamber.

15. The liquid ejection head according to claim 13, comprising:
a head substrate including a plurality of the plurality of liquid ejection head substrates.

16. A liquid ejection apparatus, comprising:
a liquid ejection head including a liquid ejection head substrate; and
a supply unit for supplying liquid to the liquid ejection head,
wherein the liquid ejection head substrate includes:
a first terminal array in which a plurality of first terminals are arranged;
a second terminal array in which a plurality of second terminals are arranged along an arrangement direction of the first terminal array;
a first element array in which a plurality of first elements are arranged along the arrangement direction of the first terminal array, the first element array being provided between the first terminal array and the second terminal array and being adjacent to the first terminal array;
a second element array in which a plurality of second elements are arranged along the arrangement direction of the second terminal array, the second element array being provided between the first terminal array and the second terminal array and being adjacent to the second terminal array;
a third element array in which a plurality of third elements are arranged, the third element array being provided between the first element array and the second element array;
at least one of first wiring configured to connect the plurality of first terminals and the plurality of first elements;
at least one of second wiring configured to connect the plurality of second terminals and the plurality of second elements; and
at least one of third wiring configured to connect the plurality of third elements and at least one of the plurality of first terminals and the plurality of second terminals.
